(19) United States
(12) Patent Application Publication
(10) Pub. No.: US 2018/0024865 A1
(43) Pub. Date: Jan. 25, 2018

(54) PARALLEL PROCESSING APPARATUS AND NODE-TO-NODE COMMUNICATION METHOD

(71) Applicant: FUJITSU LIMITED, Kawasaki-shi (JP)

(72) Inventor: Kazushige Saga, Taito (JP)

(73) Assignee: FUJITSU LIMITED, Kawasaki-shi (JP)

(21) Appl. No.: 15/614,169

(22) Filed: Jun. 5, 2017

(30) Foreign Application Priority Data
Jul. 22, 2016 (JP) 2016-144875

(51) Int. Cl. G06F 9/50; H04L 29/08; G06F 9/52

(52) U.S. Cl. CPC G06F 9/5072; G06F 9/52; H04L 67/10; G06F 17/30132

(57) ABSTRACT

A cross compiler generates a logical communication area number for first identifying information that is assigned to each of multiple processes contained in parallel processing. An area converter and an address acquisition unit keep correspondence information that makes it possible to, on the basis of the first identifying information and second identifying information representing the parallel processing, specify a memory area that is allocated according to each set of the second identifying information corresponding to the logical communication area number, receives a communication instruction containing the first identifying information, the second identifying information and the logical communication area number, and acquires a memory area corresponding to the acquired logical communication area number on the basis of the correspondence information. A communication controller performs communication by using the memory area that is acquired by the address acquisition unit.

### CROSS-REFERENCE TO RELATED APPLICATION

This application is based upon and claims the benefit of priority of the prior Japanese Patent Application No. 2016-144875, filed on Jul. 22, 2016, the entire contents of which are incorporated herein by reference.

### FIELD

The embodiments discussed herein are directed to a parallel processing apparatus and a node-to-node communication method.

### BACKGROUND

For parallel computing systems, particularly for high performance computing (HPC) systems, systems each including more than 100,000 computation nodes to realize high performance have been developed in recent years. A computing node is a unit of processor that executes information processing and, for example, a central processing unit (CPU) that is a computing processor is an exemplary computation node.

It is expected that an HPC system in the exascale era will have an enormous number of cores and nodes. It is assumed that the number of cores and the number of nodes are, for example, in the order of 1,000,000. It is also expected that the number of parallel processes of one application will amount to up to 1,000,000.

In such a high-performance HPC system, a high-performance interconnect that is a high-speed communication network device with low latency and a high bandwidth is often used for communications between computation nodes. In addition to this, a high-performance interconnect generally mounts a remote direct memory access (RDMA) function enabling direct access to a memory of a communication partner. High-performance interconnects are regarded as one of important technologies among HPC systems in the exascale era and are under development aiming at higher performance and functions easier to use.

In a mode where a high-performance interconnect is used, applications that particularly need low communication latency often use one-way communications in a RDMA communication mechanism. One-way communications in the RDMA communication mechanism may be referred to as “RDMA communication” below. RDMA communication enables direct communications between data areas of processes distributed to multiple computation nodes not via a communication buffer of software of a communication partner or a parallel computing system. For this reason, copying communication buffers and data areas by communication software in general network devices is not performed in RDMA communications and therefore communications with low latency are implemented. As RDMA communications enable direct communications between data areas (memories) of an application, information on the memory areas is exchanged in advance between communication ends. The memory areas used for RDMA communications may be referred to as “communication areas” below.

From the point of view of improvement in productivity of programs and in convenience of communications, it is assumed that communication libraries and program languages that define a common global memory address space in parallel processes and perform communications by using a global address will be heavily used. A global address is an address representing a global memory address space. Program languages for performing communications by using a global address are, for example, languages using the partitioned global address space (PGAS) system, such as Unified Parallel C (UPC) and Coarray Fortran. The source code of a parallel program using distributed processes described in any of those languages enables a process to access data of other processes other than the process as if the process accesses its own data. Thus, describing complicated processing for communication in the source code is not needed and accordingly productivity of the program improves.

With respect to conventional programming languages, when a large-scale data array is divided and the divided arrays are arranged in multiple processes, communication with a process having data to be accessed according to Message Passing Interface (MPI) is described in a source code. On the other hand, PGAS programming languages enable each process to access other processes and variables and partial arrays arranged therein according to the same description of the variable and partial array arranged in the process. The access serves as a process-to-process communication and the communication is hidden from the source program and this enables parallel programming ignoring communication and thus improves the productivity of the program.

As the number of CPU cores per computation node is small according to the conventional technology, a method used for HPC programs where one user process occupies one computation node has been a prevailing method. It is however presumed that, with an increase in the number of computation cores and the memory capacity, there will be more modes where multiple user processes share one computation node for execution. The same applies to the PGAS-system languages and thus there is a demand that global addresses of multiple user programs described in a PGAS-system language coexist in one computation node.

Furthermore, when RDMA communication is performed in a high-performance HPC system, sequential numbers are assigned respectively to the parallel processes and distributed arrays that are obtained by dividing a data array and that is allocated to ranks representing the processing corresponding to the sequential numbers are managed by using a global address. Sets of data of the distributed array allocated to the respective ranks are referred to as partial arrays. The partial arrays are, for example, allocated to all or part of the ranks and the partial arrays of the respective ranks may have the same size or different sizes. The partial arrays are stored in a memory and a memory area in which each partial array is stored is simply referred to as an “area”. The area serves as a communication area for RDMA communication. Area numbers are assigned to the areas, respectively, and the area number differs according to each rank even with respect to partial arrays of the same distributed array. In a preparation before starting RDMA communications, all ranks exchange the area numbers and offsets of partial arrays of the distributed array. Each rank manages the distributed array name, the initial element number of the partial array, the number of elements of the partial array, the rank number of the rank corresponding to the partial array, the area number, and offset information by using a communication area management table.

In order to access a given array element in a distributed array, a specific rank searches the communication area management table to acquire a rank that has the given array element and an area number and specifies an area where the given array element exists. The specific rank then specifies a computation node that processes the rank that has the given array element from the rank management table representing the computation nodes that process the respective ranks. The specific rank then accesses the given array element by performing RDMA communication according to the form of the given array element from the position at which an offset is added to the specified area of the specified computation node.

There is, as a conventional technology relating to RDMA communications, a conventional technology in which an RDMA engine converts an RDMA area identifier into a physical or virtual address to perform data transfer.

Patent Document 1: Japanese Laid-open Patent Publication No. 2009-181585

When multiple ranks in parallel processes share a distributed data array, information is exchanged by notifying all the ranks of the communication area numbers of the partial arrays that the ranks have and the address offsets in the communication areas, because the communication areas of the partial arrays of the array data are different from each other according to the rank. When there are a small number of ranks, the cost for the information exchange and the memory area consumed by the management table are small. On the other hand, in a parallel computing system that includes over 100,000 computation nodes, the following problem occurs.

For example, each rank refers to the communication area management table for each communication and this increases communication latency in the parallel computing system. The increase of communication latency in one communication is not so significant; however, the number of times an HPC application repeats referring to the communication area management table is enormous. The increase in communication latency due to the reference to the communication management table thus deteriorates the performance of execution of entire jobs in the parallel computing system.

The communication area management table keeps entries corresponding to the number obtained by multiplying the number of communication areas and the number of processes. In this respect, the large-scale parallel processing using more than 100,000 nodes uses a huge memory area for storing the communication area management table, which reduces memory areas for executing a program.

Furthermore, for example, even with the conventional technology in which an RDMA engine converts an RDMA area identifier into a physical or virtual address, it is difficult to unify the communication areas of partial arrays of the ranks and thus to realize high-speed communication processing.

### SUMMARY

According to an aspect of an embodiment, a parallel processing apparatus includes: a generator that generates a logical communication area number for first identifying information that is assigned to each of multiple processes contained in parallel processing; an acquisition unit that keeps correspondence information that makes it possible to, on the basis of the first identifying information and second identifying information representing the parallel processing, specify a memory area that is allocated according to each set of the second identifying information corresponding to the logical communication area number, receives a communication instruction containing the first identifying information, the second identifying information and the logical communication area number, and acquires a memory area corresponding to the acquired logical communication area number on the basis of the correspondence information; and a communication unit that performs communication by using the memory area that is acquired by the acquisition unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an exemplary HPC system;

FIG. 2 is a hardware configuration diagram of a computation node;

FIG. 3 is a diagram illustrating a software configuration of a management node;

FIG. 4 is a block diagram of a computation node according to a first embodiment;

FIG. 5 is a diagram for explaining a distributed shared array;

FIG. 6 is a diagram of an exemplary rank computation node correspondence table;

FIG. 7 is a diagram of an exemplary communication area management table;

FIG. 8 is a diagram of an exemplary table selecting mechanism;

FIG. 9 is a diagram for explaining a process of specifying a memory address of an array element to be accessed, which is a process performed by the computation node according to the first embodiment;

FIG. 10 is a flowchart of a preparation process for RDMA communication;

FIG. 11 is a flowchart of a process of initializing a global address mechanism;

FIG. 12 is a flowchart of a communication area registration process;

FIG. 13 is a flowchart of a data copy process using RDMA communication;

FIG. 14 is a flowchart of a remote-to-remote copy process;

FIG. 15 is a diagram of an exemplary communication area management table in the case where a distributed shared array is allocated to part of ranks;

FIG. 16 is a diagram of an exemplary communication area management table obtained when the size of the partial array differs according to each rank;

FIG. 17 is a block diagram of a computation node according to a second embodiment;

FIG. 18 is a diagram for explaining a process of specifying a memory address of an array element to be accessed, which is a process performed by the calculation node according to the second embodiment;

FIG. 19 is a diagram of an exemplary variable management table; and

FIG. 20 is a diagram of an exemplary variable management table obtained when two shared variables are collectively managed.

### DESCRIPTION OF EMBODIMENTS

Preferred embodiments of the present invention will be explained with reference to accompanying drawings. The following embodiments do not limit the parallel processing apparatus and the node-to-node communication method disclosed herein.

### [a] First Embodiment

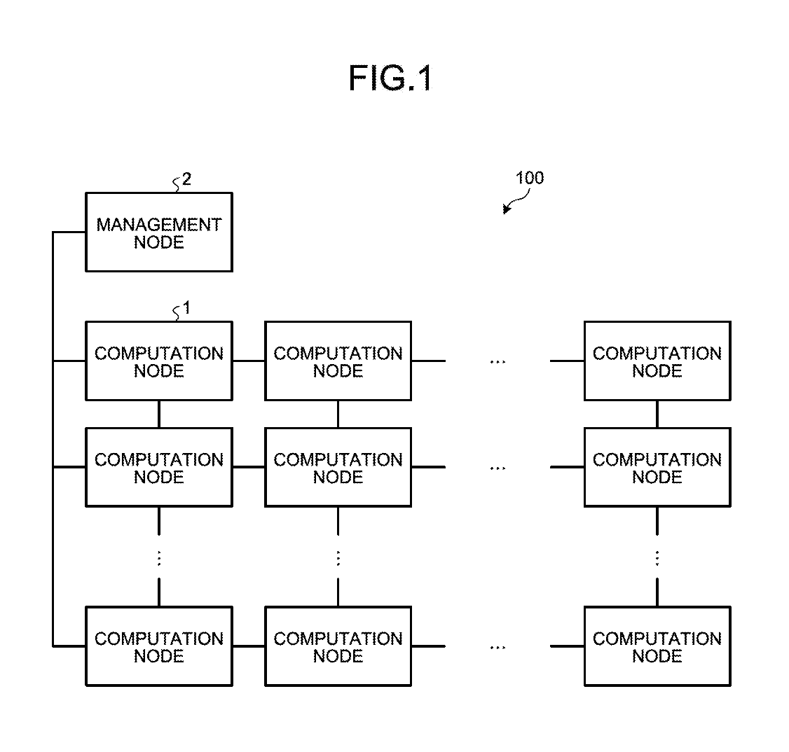

FIG. 1 is a configuration diagram illustrating an exemplary HPC system. As illustrated in FIG. 1, an HPC system 100 includes a management node 2 and multiple computation nodes 1. FIG. 1 illustrates only the single management node 2; however, practically, the HPC system 100 may include multiple management nodes 2. The HPC system 100 serves as an exemplary “parallel processing apparatus”.

The computation node 1 is a node for executing a computation process to be executed according to an instruction issued by a user. The computation node 1 executes a parallel program to perform arithmetic processing. The computation node 1 is connected to other nodes 1 via an interconnect. When executing the parallel program, for example, the computation node 1 performs RDMA communications with other computation nodes 1.

The parallel program is a program that is assigned to multiple computation nodes 1 and is executed by each of the computation nodes 1, so that a series of processes is executed. Each of the computation nodes 1 executes the parallel program and accordingly each of the computation nodes 1 generates a process. The collection of the processes that are generated by the computation nodes 1 is referred to as parallel processing. The identifying information of the parallel processing serves as “second identifying information”. The processes that are executed by the respective computation nodes 1 when each of the computation nodes 1 executes the parallel program may be referred to as “jobs”.

Sequential numbers are assigned to the respective processes that constitute a set of parallel processing. The sequential numbers assigned to the processes will be referred to as “ranks” below. The ranks serve as “first identifying information”. The processes corresponding to the ranks may be also referred to as “ranks” below. One computation node 1 may execute one rank or multiple ranks.

The management node 2 manages the entire system including operations and management of the computation nodes 1. The management node 2, for example, monitors the computation nodes 1 on whether an error occurs and, when an error occurs, executes a process to deal with the error.

The management node 2 allocates jobs to the computation nodes 1. For example, a terminal device (not illustrated) is connected to the management node 2. The terminal device is a computer that is used by an operator that issues an instruction on the content of a job to be executed. The management node 2 receives inputs of the content of the job to be executed and an execution request from the operator via the terminal device. The content of the job contains the parallel program and data to be used to execute the job, the type of the job, the number of cores to be used, the memory capacity to be used and the maximum time spent to execute the job. On receiving the execution request, the management node 2 transmits a request to execute the parallel program to the computation nodes 1. The management node 2 then receives the job processing result from the computation nodes 1.

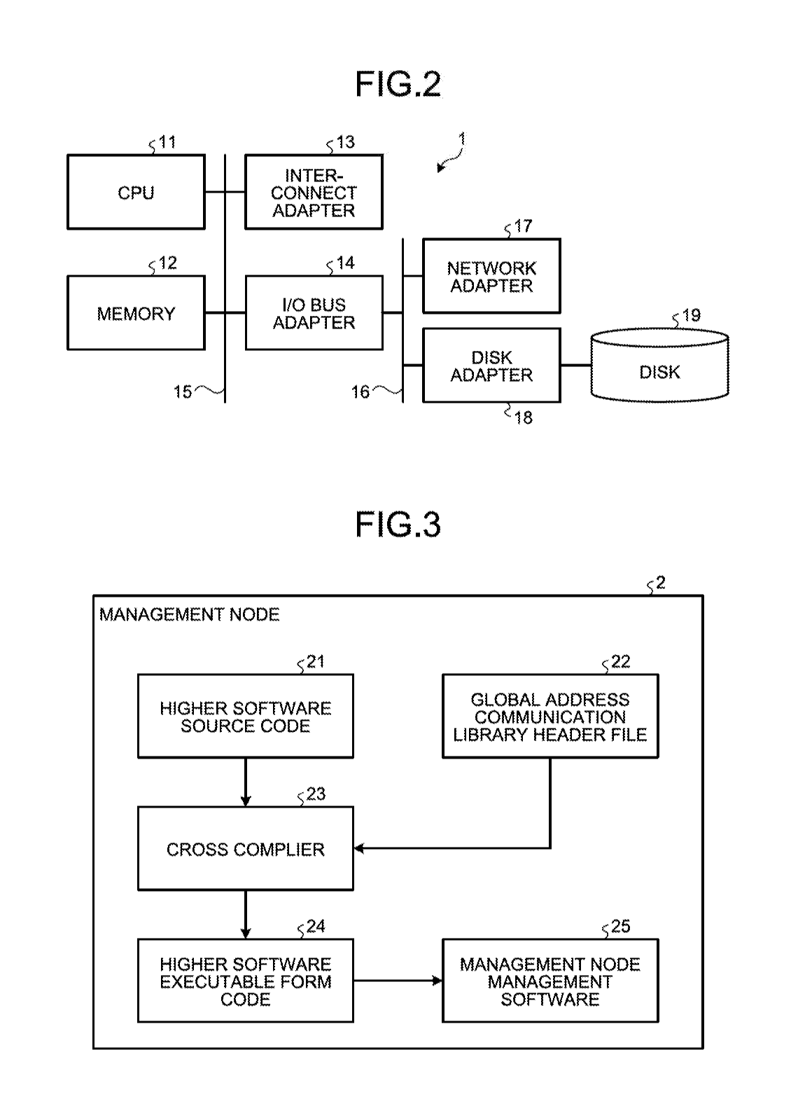

FIG. 2 is a hardware configuration diagram of the computation node. The computation node 1 will be exemplified here, and the management node 2 has the same configuration in the embodiment.

As illustrated in FIG. 2, the computation node 1 includes a CPU 11, a memory 12, an interconnect adapter 13, an Input/Output (I/O) bus adapter 14, a system bus 15, an I/O bus 16, a network adapter 17, a disk adapter 18 and a disk 19.

The CPU 11 connects to the memory 12, the interconnect adapter 13 and the I/O bus adapter 14 via the system bus 15. The CPU 11 controls the entire device of the computation node 1. The CPU 11 may be a multicore processor. At least part of the functions implemented by the CPU 11 by executing the parallel program may be implemented with an electronic circuit, such as an application specific integrated circuit (ASIC) or a digital signal processor (DSP). The CPU 11 communicates with other computation nodes 1 and the management node 2 via the interconnect adapter 13, which will be described below. The CPU 11 generates a process by executing various programs from the disk 19, which will be described below, including a program of an operating system (OS) and an application program.

The memory 12 is a main memory of the computation node 1. The various programs including the OS program and the application program that are read by the CPU 11 from the disk 19 are loaded into the memory 12. The memory 12 stores various types of data used for processes that are executed by the CPU 11. For example, a random access memory (RAM) is used as the memory 12.

The interconnect adapter 13 includes an interface for connecting to another computation node 1. The interconnect adapter 13 connects to an interconnect router or a switch that is connected to other computation nodes 1. For example, the interconnect adapter 13 performs RDMA communication with the interconnect adapters 13 of other computation nodes 1.

The I/O bus adapter 14 is an interface for connecting to the network adapter 17 and the disk 19. The I/O bus adapter 14 connects to the network adapter 17 and the disk adapter 18 via the I/O bus 16. FIG. 2 exemplifies the network adapter 17 and the disk 19 as peripherals, and other peripherals may be additionally connected. The interconnect adapter may be connected to the I/O bus.

The network adapter 17 includes an interface for connecting to the internal network of the system. For example, the CPU 11 communicates with the management node 2 via the network adapter 17.

The disk adapter 18 includes an interface for connecting to the disk 19. The disk adapter 18 writes data in the disk 19 or reads data from the disk 19 according to a data write command or a data read command from the CPU 11.

The disk 19 is an auxiliary storage device of the computation node 1. The disk 19 is, for example, a hard disk. The disk 19 stores various programs including the OS program and the application program and various types of data.

The computation node 1 need not include, for example, the I/O bus adapter 14, the I/O bus 16, the network adapter 17, the disk adapter 18 and the disk 19. In that case, for example, an I/O node that includes the disk 19 and that executes the I/O process on behalf of the computation node 1 may be mounted on the HPC system 100. The management node 2 may be, for example, configured not to include the interconnect adapter 13.

With reference to FIG. 3, the software of the management node 2 will be described. FIG. 3 is a diagram illustrating the software configuration of the management node.

The management node 2 includes a higher software source code 21 and a global address communication library header file 22 representing the header of a library for global address communication in the disk 19. The higher software is an application containing the parallel program. The management node 2 may acquire the higher software source code 21 from the terminal device.

The management node 2 further includes a cross compiler 23. The cross compiler 23 is executed by the CPU 11. The cross compiler 23 of the management node 2 compiles the higher software source code 21 by using the global address communication library header file 22 to generate a higher software executable form code 24. The higher software executable form code 24 is, for example, an executable form code of the parallel program.

The cross compiler 23 determines a variable to be shared by a global address and a logical communication area number that is a logical communication area number for each distributed shared array. The global address is an address representing a common global memory address space in the parallel processing. The distributed shared array is a virtual one-dimensional array obtained by implementing distributed sharing on a given data array with respect to each rank, and the sequential element numbers represent the communication areas used by the ranks, respectively. The cross compiler 23 uses the same logical communication area number for all the ranks as the logical communication area number.

The cross compiler 23 buries the determined variable and logical communication area number in the generated higher software executable form code 24. The cross compiler 23 then stores the generated higher software executable form code 24 in the disk 19. The cross compiler 23 serves as an exemplary “generator”.

Management node management software 25 is a software group for implementing various processes, such as operations and management of the computation nodes 1, executed by the management node 2. The CPU 11 executes the management node management software 25 to implement the various processes, such as operations and management of the computation nodes 1. For example, the CPU 11 executes the management node management software 25 to cause the computation node 1 to execute a job that is specified by the operator. In this case, by being executed by the CPU 11, the management node management software 25 determines a parallel processing number that is identifying information of the parallel processing and a rank number that is assigned to each computation node 1 that executes the paralleled processing. The rank number serves as exemplary “first identifying information”. The parallel processing number serves as exemplary “second identifying information”. The CPU 11 executes the management node management software 25 to transmit the higher software executable form code 24 to the computation node 1 together with the parallel processing number and the rank number assigned to the computation node 1.

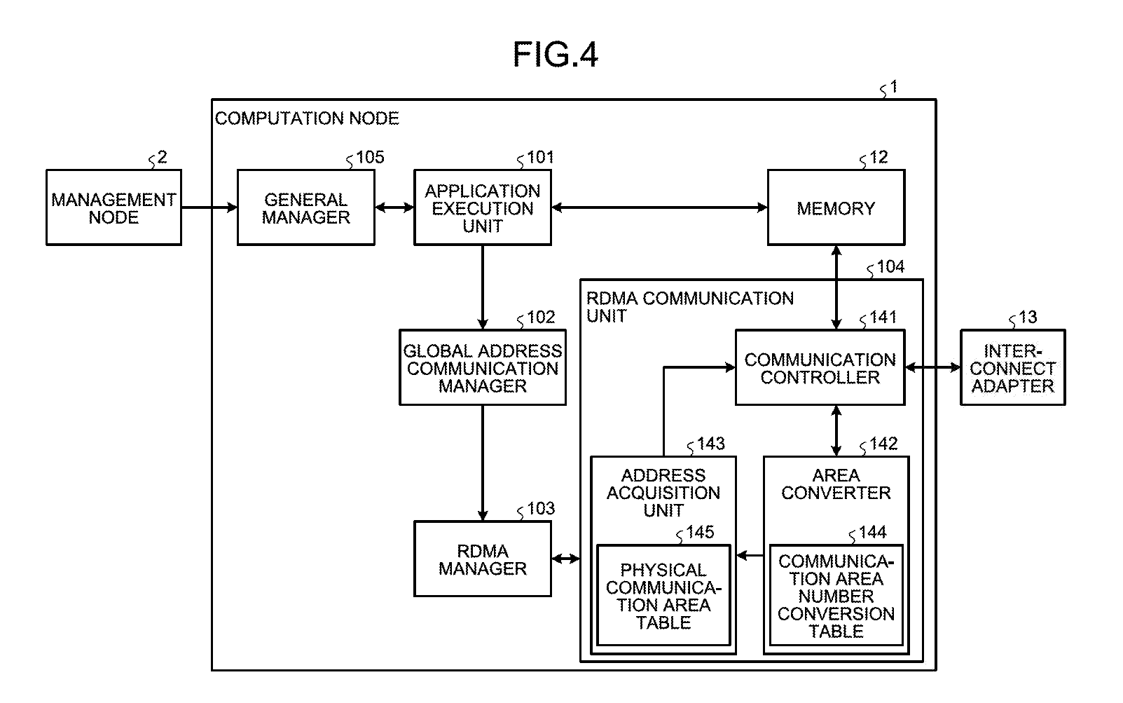

With reference to FIG. 4, the computation node 1 according to the embodiment will be described in detail. FIG. 4 is a block diagram of the computation node according to the first embodiment. As illustrated in FIG. 4, the computation node 1 according to the embodiment includes an application execution unit 101, a global address communication manager 102, a RDMA manager 103 and a RDMA communication unit 104. The functions of the application execution unit 101, the global address communication manager 102, the RDMA manager 103 and a general manager 105 are implemented by the CPU 11 and the memory 12 illustrated in FIG. 2. The case where the parallel program is executed as the higher software will be described.

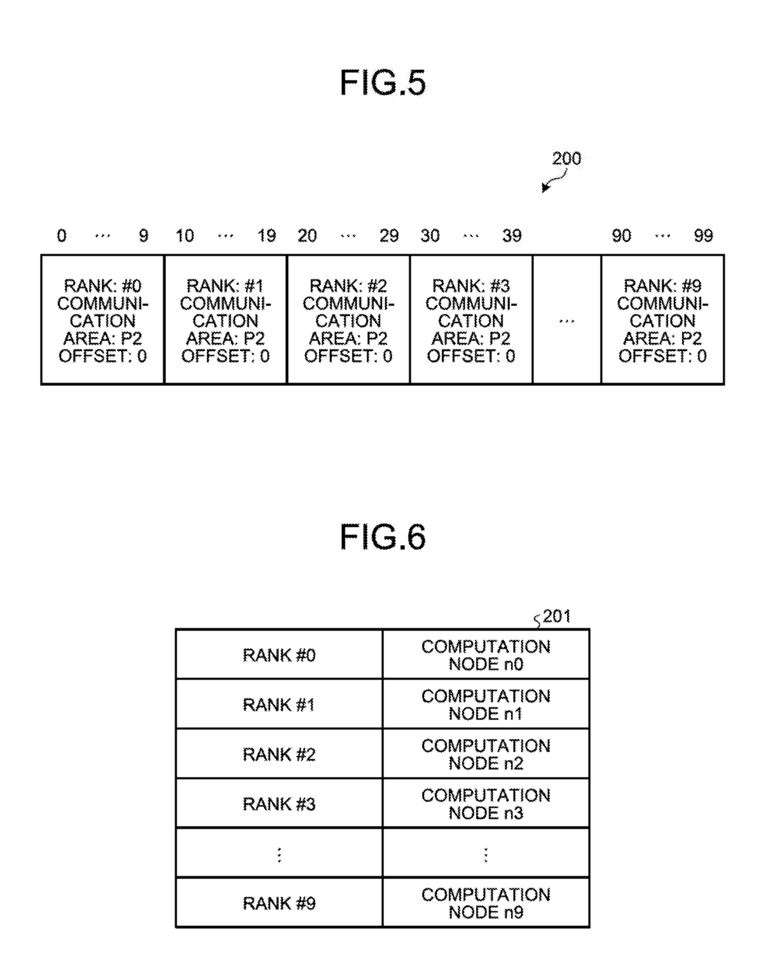

The computation node 1 executes the parallel program by using a distributed shared array like that illustrated in FIG. 5. FIG. 5 is a diagram for explaining the distributed shared array. A distributed shared array 200 illustrated in FIG. 5 has 10 ranks to each of which a partial array consisting of 10 elements is allocated.

Sequential element numbers from 0 to 99 are assigned to the distributed shared array 200. The embodiment will be described as the case where the distributed and shared array is divided equally by each rank, i.e., the case where the partial arrays allocated to the respective ranks have the same size. In this case, every ten elements of the distributed shared array 200 are allocated as a partial array to each of the ranks #0 to #9. Furthermore, as described above, according to the embodiment, the cross compiler 23 uniquely determines a logical communication area number with respect to each distributed shared array. For example, all the logical communication area numbers of the ranks #0 to #9 are P2. Furthermore, in this case, the offset is 0. Practically, any value may be used as the offset.

The general manager 105 executes computation node management software for performing general management on the computation nodes 1 to perform general management on the entire computation nodes 1, such as timing adjustment. The general manager 105 acquires an execution code of the parallel program as the higher software executable form code 24 together with an execution request from the management node 2. The general manager 105 further acquires, from the management node 2, the parallel processing number and the rank numbers assigned to the respective computation nodes 1 that execute the parallel processing.

The general manager 105 outputs the parallel processing number and the rank numbers of the computation nodes 1 to the application execution unit 101. The general manager 105 further performs initialization on hardware that is used for RDMA communication, for example, setting authority of a user process to access hardware, such as a RDMA-NIC (Network Interface Controller) of the RDMA communication unit 104. The general manager 105 further makes a setting to enable the hardware used for RDMA communication.

The general manager 105 further adjusts the execution timing and causes the application execution unit 101 to execute the execution code of the parallel program. The general manager 105 acquires the result of execution of the parallel program from the application execution unit 101. The general manager 105 then transmits the acquired execution result to the management node 2.

The application execution unit 101 receives an input of the parallel processing number and the rank numbers of the respective computation nodes from the general manager 105. The application execution unit 101 further receives an input of the executable form code of the parallel program together with the execution request from the general manager 105. The application execution unit 101 executes the acquired executable form code of the parallel program, thereby forming processing to execute the parallel program.

After executing the parallel program, the application execution unit 101 acquires the result of the execution. The application execution unit 101 then outputs the execution result to the general manager 105.

The application execution unit 101 executes the process below as a preparation for RDMA communication. The application execution unit 101 acquires the parallel processing number of the formed parallel processing and the rank number of the process. The application execution unit 101 outputs the acquired parallel processing number and the rank number to the global address communication manager 102. The application execution unit 101 then notifies the global address communication manager 102 of an instruction for initializing of the global address mechanism.

After completion of initialization of the global address mechanism, the application execution unit 101 notifies the global address communication manager 102 of an instruction for initializing communication area number conversion tables 144.

The application execution unit 101 then generates a rank computation node correspondence table 201 that is illustrated in FIG. 6 and that represents the correspondence between ranks and the computation nodes 1. FIG. 6 is a diagram of an exemplary rank computation node correspondence table. The rank computation node correspondence table 201 is a table representing the computation nodes 1 that processes the ranks, respectively. In the rank computation node correspondence table 201, the numbers of the computation nodes 1 are registered in association with the rank numbers. For example, the rank computation node correspondence table 201 illustrated in FIG. 6 represents that the rank #1 is processed by the computation node n1. The application execution unit 101 outputs the generated rank computation node correspondence table 201 to the global address communication manager 102.

The application execution unit 101 acquires a global address variable and an array memory area that is statically obtained. Accordingly, the application execution unit 101 determines the memory area to be allocated to each rank that shares each distributed shared array. The application execution unit 101 then transmits the initial address of the acquired memory area, the area size, and the logical communication area number that is determined on the compiling and that is acquired from the general manager 105 to the global address communication manager 102 and instructs the global address communication manager 102 to register the communication area.

After the communication area is registered, the application execution unit 101 synchronizes all the ranks in order to wait for the end of registration with respect to all the ranks corresponding to the parallel program to be executed. According to the embodiment, the application execution unit 101 recognizes the end of the process of registration with respect to each rank by performing a process-to-process synchronization process. This enables the application execution unit 101 to perform synchronization easily and speedily compared to the case where information on communication areas is exchanged. With respect to a variable and an array area that are acquired dynamically, the application execution unit 101 performs registration and rank-to-rank synchronization at appropriate timings. The process-to-process synchronization process may be implemented by either software or hardware.

When data is transmitted and received by performing RDMA communication, the application execution unit 101 transmits information on an array element to be accessed in RDMA communications to the global address communication manager 102. The information on the array element to be accessed contains identifying information of the distributed shared array to be used and element number information. The application execution unit 101 serves as an exemplary “memory area determination unit”.

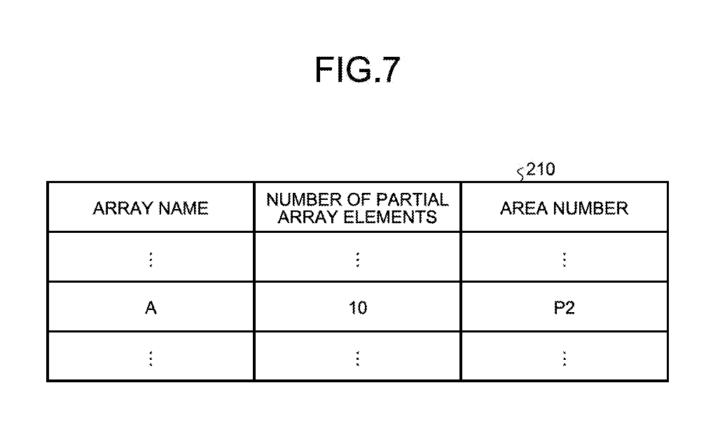

The global address communication manager 102 has a global address communication library. The global address communication manager 102 has a communication area management table 210 illustrated in FIG. 7. FIG. 7 is a diagram of an exemplary communication area management table. The communication area management table 210 represents that partial arrays of the distributed shard array whose array name is “A” are equally allocated to all the ranks that executes the parallel processing. According to the communication area management table 210, the number of partial array elements allocated to each rank is “10” and the logical communication area number is “P2”. In other words, FIG. 7 is obtained by assigning “A” as the array name of the distributed shared array 200 illustrated in FIG. 5. As described above, the computation node 1 according to the embodiment is able to use the communication area management table 210 having one entry with respect to one distributed shared array. In other words, the computation node 1 according to the embodiment enables reduction of the use of the memory 12 compared to the case where a table having entries with respect to respective ranks sharing a distributed shared array is used.

The global address communication manager 102 receives the notification indicating initialization of the global address mechanism from the application execution unit 101. The global address communication manager 102 determines whether there is the communication area number conversion table 144 unused.

The communication area number conversion table 144 is a table for, when the RDMA communication unit 104 to be described below performs RDMA communication, converting a logical communication area number into a physical communication area number. The communication area number conversion table 144 is provided as hardware in the RDMA communication unit 104. In other words, the communication area number conversion table 144 uses the resource of the RDMA communication unit 104. For this reason, it is preferable that the number of the usable communication area number conversion tables 144 be determined according to the resources of the RDMA communication unit 104. The global address communication manager 102 stores an upper limit of the number of usable communication area number conversion tables 144 in advance and, when the number of the communication area number conversion tables 144 reaches the upper limit, determines that there is not the communication area number conversion table 144 unused.

When there is the communication area number conversion table 144 unused, the global address communication manager 102 assigns a table number to the communication area number conversion table 144 that uniquely corresponds to the combination of the parallel processing number and the rank number. The global address communication manager 102 instructs the RDMA manager 103 to set a parallel processing number and a rank number corresponding to each table number in a table selecting register that an area converter 142 has.

After the setting in the table selecting register completes, the global address communication manager 102 receives an instruction for initializing the communication area number conversion tables 144 from the application execution unit 101. The global address communication manager 102 then instructs the RDMA manager 103 to initialize the communication area number conversion tables 144.

The global address communication manager 102 then receives an instruction for registering the communication area from the application execution unit 101 together with the initial address, the area size and the logical communication area number that is determined on the compiling and is acquired from the general manager 105. The global address communication manager 102 transmits the initial address, the area size, and the logical communication area number that is determined on the compiling and is acquired from the general manager 105 to the RDMA manager 103 and instructs the RDMA manager 103 to register the communication area.

Furthermore, when data is transmitted and received by performing RDMA communication, the global address communication manager 102 receives an input of information on an array element to be accessed from the application execution unit 101. For example, the global address communication manager 102 acquires the identifying information of a distributed shared array and an element number as the information on the array element to be accessed.

The global address communication manager 102 then starts a process of copying data by performing RDMA communication using the global address of the source of communication and the communication partner. The global address communication manager 102 computes and obtains an offset of an element in an array to be copied by the application and then determines a data transfer size from the number of elements of the array to be copied. The global address communication manager 102 acquires a rank number from the global address by using the communication area management table 210. The global address communication manager 102 then acquires the network addresses of the computation nodes 1 that are the source of communication and the communication partner of RDMA communication from the rank computation node correspondence table 201. The global address communication manager 102 then determines whether it is communication involving the node or a remote-to-remote copy from the acquired network addresses.

When it is communication involving the node, the global address communication manager 102 notifies the RDMA manager 103 of the global address of the source of communication and the communication partner and the parallel processing number.

When it is a remote-to-remote copy, the global address communication manager 102 notifies the RDMA manager 103 of the computation node 1, serving as the source of communication of the remote-to-remote copy, of the global address of the source of communication and the communication partner and the parallel processing number. The global address communication manager 102 serves as an exemplary “correspondence information generator”.

The RDMA manager 103 has a root authority to control the RDMA communication unit 104. The RDMA manager 103 receives, from the global address communication manager 102, an instruction for setting the parallel processing number and the rank number corresponding to the table number in the table selecting register from the global address communication manager 102. The RDMA manager 103 then registers the parallel processing number and the rank number in association with the table number in the table selecting register of the area converter 142.

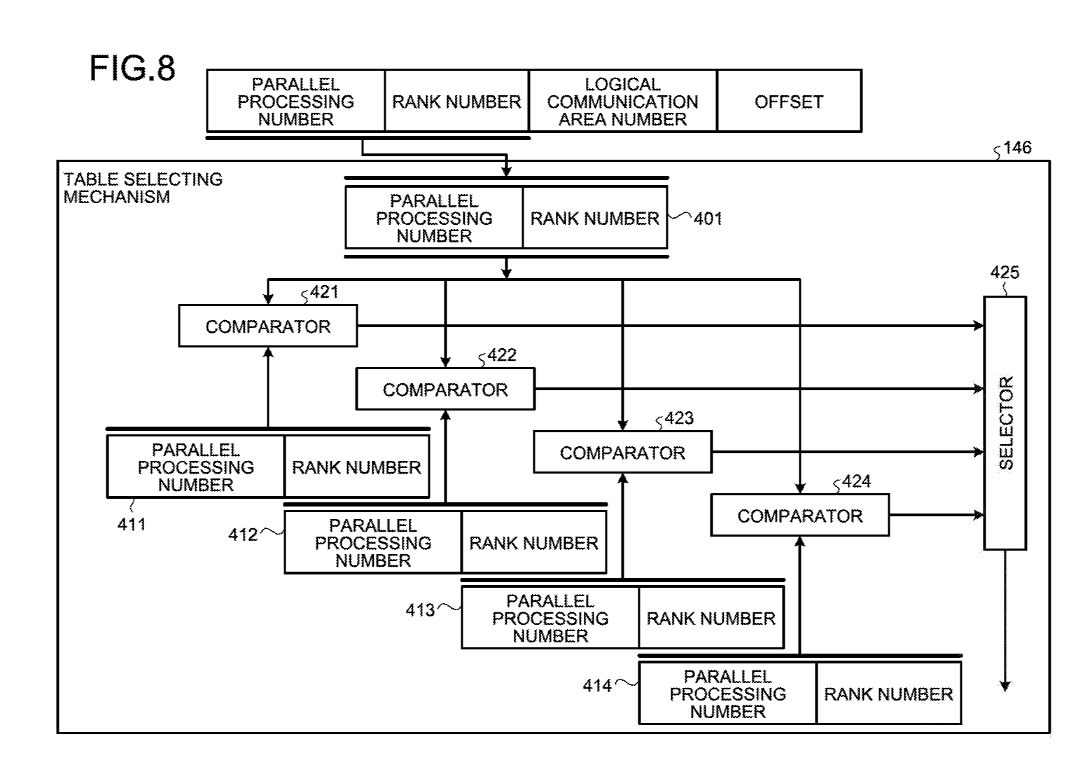

FIG. 8 is a diagram of an exemplary table selecting mechanism. A table selecting mechanism 146 is a circuit for selecting the communication area number conversion table 144 corresponding to a global address. The table selecting mechanism 146 includes a register 401, table selecting registers 411 to 414, comparators 421 to 424, and a selector 425.

The table selecting registers 411 to 414 correspond to specific table numbers, respectively. FIG. 8 illustrates the case where there are the four table selecting registers 411 to 414. For example, the table numbers of the table selecting registers 411 to 414 correspond to the communication area number conversion tables 144 whose table numbers are 1 to 4. The RDMA manager 103 registers the parallel process numbers and the rank numbers in the table selecting registers 411 to 414 according to the corresponding numbers of the communication area number conversion tables 144. The table selecting mechanism 146 of the area converter 142 will be described in detail below.

The RDMA manager 103 then receives an instruction for initializing the communication area number conversion tables 144 from the global address communication manager 102. The RDMA manager 103 then initializes all the entries of the communication area number conversion tables 144 of the area converter 142 corresponding to the table selecting registers 411 to 414 on which the setting is made to an unused state.

The RDMA manager 103 receives, from the global address communication manager 102, an instruction for registering a communication area together with the initial address of each partial array, the area size, and the logical communication area number that is determined on the compiling and acquired from the general manager 105. The RDMA manager 103 then determines whether there is a physical communication area table 145 that is usable. The physical communication area table 145 is a table for specifying the initial address and the area size from the physical communication area number. The physical communication area table 145 is provided as hardware in an address acquisition unit 143. For this reason, it is preferable that the size of the useable physical communication area table 145 be determined according to the resources of the RDMA communication unit 104. The RDMA manager 103 stores an upper limit of the size of the useable physical communication area tables 145 and, when the size of the physical communication area tables 145 already used reaches the upper limit, determines that there is not the usable a vacancy in physical communication area table 145.

When there is the usable a vacancy in physical communication area table 145, the RDMA manager 103 registers the initial address of each partial array and the area size, which are received from the global address communication manager 102, in the physical communication area table 145 that is provided in the address acquisition unit 143. The RDMA manager 103 acquires, as the physical communication area number, the entry in which each initial address and each size are registered. In other words, the RDMA manager 103 acquires a physical communication area number with respect to each rank.

Furthermore, the RDMA manager 103 selects the communication area number conversion table 144 that is specified by the global address of each rank that is represented by the parallel processing number and the rank number. The RDMA manager 103 then stores a physical communication area number corresponding to the rank corresponding to the selected communication area number conversion table 144 in the entry represented by the received logical communication area number in the selected communication area number conversion table 144.

When data is transmitted and received by performing RDMA communication, the RDMA manager 103 acquires the global address of the source of communication and the communication partner and the parallel processing number from the global address communication manager 102. The RDMA manager 103 then sets the acquired global address of the source of communication and the communication partner and the parallel processing number in the communication register. The RDMA manager 103 then outputs information on an array element to be accessed containing the identifying information of the distributed shared array and the element number to the RDMA communication unit 104. The RDMA manager 103 then writes a communication command according to the communication direction in a command register of the RDMA communication unit 104 to start communication.

The RDMA communication unit 104 includes the RDMA-NIC (Network Interface Controller) that is hardware that performs RDMA communication. The RDMA-NIC includes a communication controller 141, the area converter 142 and the address acquisition unit 143.

The communication controller 141 includes the communication register that stores information used for communication and the command register that stores a command. When a communication command is written in the command register, the communication controller 141 performs RDMA communication by using the global address of the source of communication and the communication partner and the parallel processing number that are stored in the communication register.

For example, when the node is the source of data transmission, the communication controller 141 obtains the memory address from which data is acquired in the following manner. By using the information on an array element to be accessed containing the acquired identifying information of the distributed shared array and the element number, the communication controller 141 acquires the rank number and the logical communication area number that has the specified element number. The communication controller 141 then outputs the parallel processing number, the rank number and the logical communication area number to the area converter 142.

The communication controller 141 then receives an input of the initial address of the array element to be accessed and the size from the address acquisition unit 143. The communication controller 141 then combines the offset stored in the communication packet with the initial address and the size to obtain the memory address of the array element to be accessed. In this case, as it is the source of data transmission, the memory address of the array element to be accessed is the memory address from which data is read.

The communication controller 141 then sets the parallel processing number, the rank number and the logical communication area number representing the global address of the communication partner, and the offset in the header of the communication packet. The communication controller 141 then reads only the determined size of data from the obtained memory address of the array element to be accessed and transmits a communication packet obtained by adding the communication packet header to the read data to the network address of the computation node 1, which is the communication partner, via the interconnect adapter 13.

When the node serves as a node that receives data, the communication controller 141 receives, via the interconnect adapter 13, a communication packet containing the parallel processing number, the rank number and the logical communication area number representing the global address, the offset and the data. The communication controller 141 then extracts the parallel processing number and the rank number and the logical communication area number representing the global address from the header of the communication packet.

The communication controller 141 then outputs the parallel processing number, the rank number and the logical communication area number to the area converter 142. The communication controller 141 then receives an input of the initial address and the size of the array element to be accessed from the address acquisition unit 143. The communication controller 141 then confirms that the size of communication area is not exceeded from the acquired size and the offset extracted from the communication packet. When the size of the communication area is exceeded, the RDMA communication unit 104 sends back an error packet to the RDMA manager 103.

The communication controller 141 then obtains the memory address of the array element to be accessed by adding the offset in the communication packet to the initial address and the size. In this case, as this is the partner that receives data, the memory address of the array element to be accessed is the memory address for storing data. The communication controller 141 stores the data in the obtained memory address of the array element to be accessed. The communication controller 141 serves as an exemplary “communication unit”.

The area converter 142 stores the communication area number conversion table 144 that is registered by the RDMA manager 103. The area converter 142 includes the table selecting mechanism 146 illustrated in FIG. 8. The communication area number conversion table 144 serves as exemplary “first correspondence information”.

When data is transmitted and received by performing RDMA communication, the area converter 142 acquires the parallel processing number, the rank number, and the logical communication area number from the communication controller 141. The area converter 142 then selects the communication area number conversion table 144 according to the parallel processing number and the rank number.

Selecting the communication area number conversion table 144 will be described in detail with reference to FIG. 8. The area converter 142 stores the parallel processing number and the rank number that are acquired from the communication controller 141 in the register 401.

The comparator 421 compares the values that are stored in the register 401 with the values that are stored in the table selecting register 411. When the sets of values match, the comparator 421 outputs a signal indicating the match to the selector 425. The comparator 422 compares the values that are stored in the register 401 with the values that are stored in the table selecting register 412. When the sets of values match, the comparator 422 outputs a signal indicating the match to the selector 425. The comparator 423 compares the values that are stored in the register 401 with the values that are stored in the table selecting register 413. When the values match, the comparator 423 outputs a signal indicating the match to the selector 425. The comparator 424 compares the values that are stored in the register 401 with the values that are stored in the table selecting register 414. When the sets of values match, the comparator 424 outputs a signal indicating the match to the selector 425. When the communication area number conversion table 144 corresponding to the parallel processing number and the rank number is not registered, the RDMA communication unit 104 sends back an error packet to the RDMA manager 103.

On receiving the signal indicating the match from the comparator 421, the selector 425 outputs a signal to select the communication area number conversion table 144 whose table number is 1. On receiving the signal indicating the match from the comparator 422, the selector 425 outputs a signal to select the communication area number conversion table 144 whose table number is 2. On receiving the signal indicating the match from the comparator 423, the selector 425 outputs a signal to select the communication area number conversion table 144 whose table number is 3. On receiving the signal indicating the match from the comparator 424, the selector 425 outputs a signal to select the communication area number conversion table 144 whose table number is 4. The area converter 142 selects the communication area number conversion table 144 corresponding to the number that is output from the selector 425.

The area converter 142 then acquires the physical communication area number corresponding to the logical communication area number from the selected communication area number conversion table 144. The area converter 142 then outputs the acquired physical communication area number to the address acquisition unit 143. The area converter 142 serves as an exemplary “specifying unit”.

The address acquisition unit 143 stores the physical communication area table 145. The physical communication area table 145 serves as exemplary “second correspondence information”. The address acquisition unit 143 receives an input of the physical communication area number from the area converter 142. The address acquisition unit 143 then acquires the initial address and the size corresponding to the acquired physical communication area number from the physical communication area table 145. The address acquisition unit 143 then outputs the acquired initial address and the size to the communication controller 141.

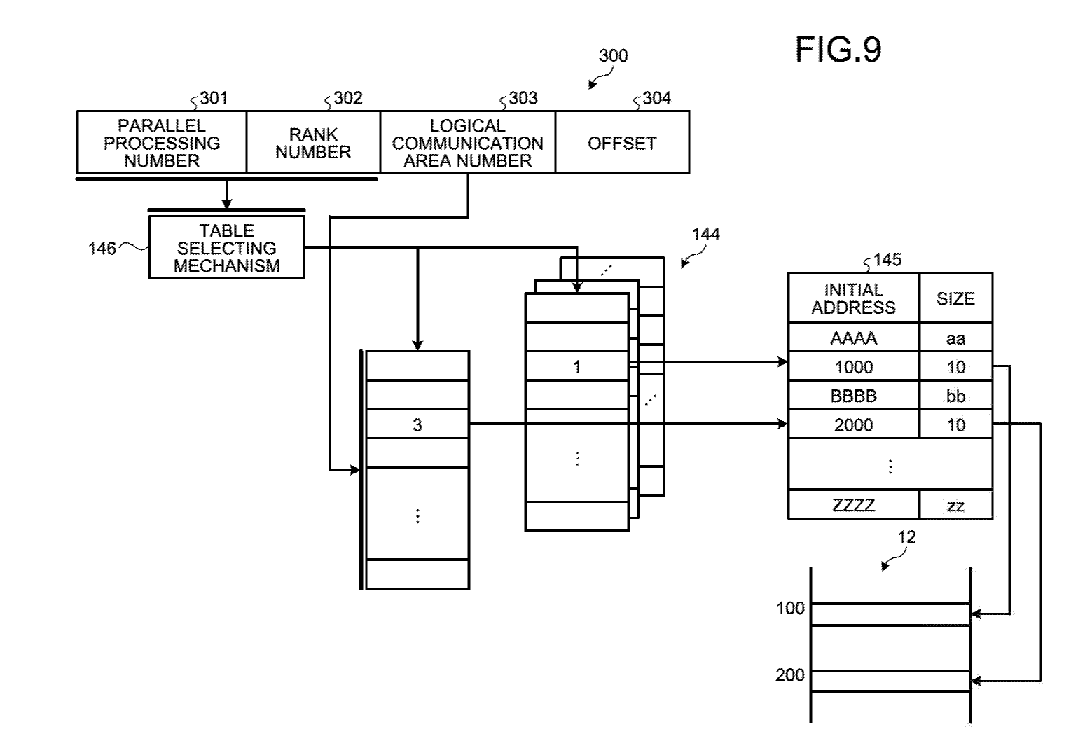

With reference to FIG. 9, the process of specifying a memory address of an array element to be accessed will be described as a summary. FIG. 9 is a diagram for explaining the process of specifying a memory address of an array element to be accessed, which is the process performed by the computation node according to the first embodiment. The case where an array element to be accessed with respect to a communication packet having a packet header 300 is obtained will be described. The packet header 300 contains a parallel processing number 301, a rank number 302, a logical communication area number 303 and an offset 304.

The table selecting mechanism 146 is a mechanism that the area converter 142 includes. The table selecting mechanism 146 acquires the parallel processing number 301 and the rank number 302 in the packet header 300 from the communication controller 141. The table selecting mechanism 146 selects the communication area number conversion table 144 corresponding to the parallel processing number 301 and the rank represented by the rank number 302.

Using the communication area number conversion table 144 that is selected by the table selecting mechanism 146, the area converter 142 outputs the physical communication area number corresponding to the logical communication area number 303.

Using the physical communication area number that is output from the area converter 142 for the physical communication area table 145, the address acquisition unit 143 outputs the initial address and the size corresponding to the physical communication area number.

The communication controller 141 obtains a memory address on the basis of the initial address and the size that are output by the address acquisition unit 143. The communication controller 141 accesses the area of the memory 12 corresponding to the memory address.

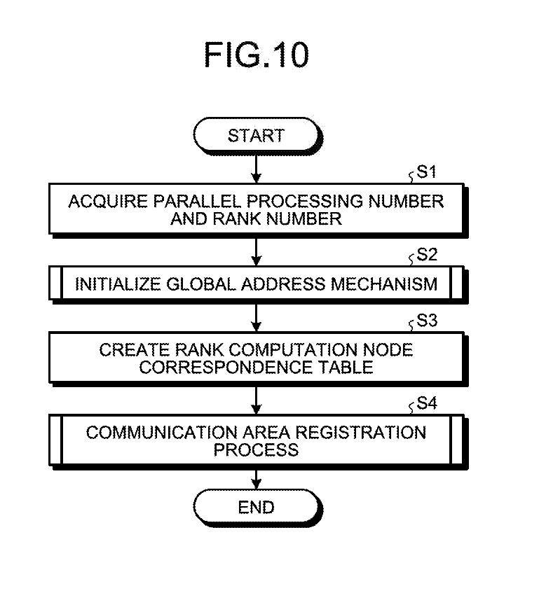

With reference to FIG. 10, a flow of the preparation process for RDMA communication will be described. FIG. 10 is a flowchart of the preparation process for RDMA communication.

The general manager 105 receives, from the management node 2, a parallel processing number that is assigned to a parallel program to be executed and rank numbers that are assigned to the respective computation nodes 1 that executes the parallel processing (step S1). The general manager 105 outputs the parallel processing number and the rank numbers to the application execution unit 101. The application execution unit 101 forms a process by executing the parallel program. The application execution unit 101 further transmits the parallel processing number and the rank umbers to the global address communication manager 102. The application execution unit 101 further instructs the global address communication manager 102 to initialize the global address mechanism. The global address communication manager 102 then instructs the RDMA manager 103 to initialize the global address mechanism.

The RDMA manager 103 receives an instruction for initializing the global address mechanism from the global address communication manager 102. The RDMA manager 103 executes initialization of the global address mechanism (step S2). Initialization of the global address mechanism will be described in detail below.

After initialization of the global address mechanism completes, the application execution unit 101 generates the rank computation node correspondence table 201 (step S3).

The application execution unit 101 then instructs the global address communication manager 102 to perform the communication area registration process. The global address communication manager 102 instructs the RDMA manager 103 to perform the communication area registration process. The global address communication manager 102 executes the communication area registration process (step S4). The communication area registration process will be described in detail below.

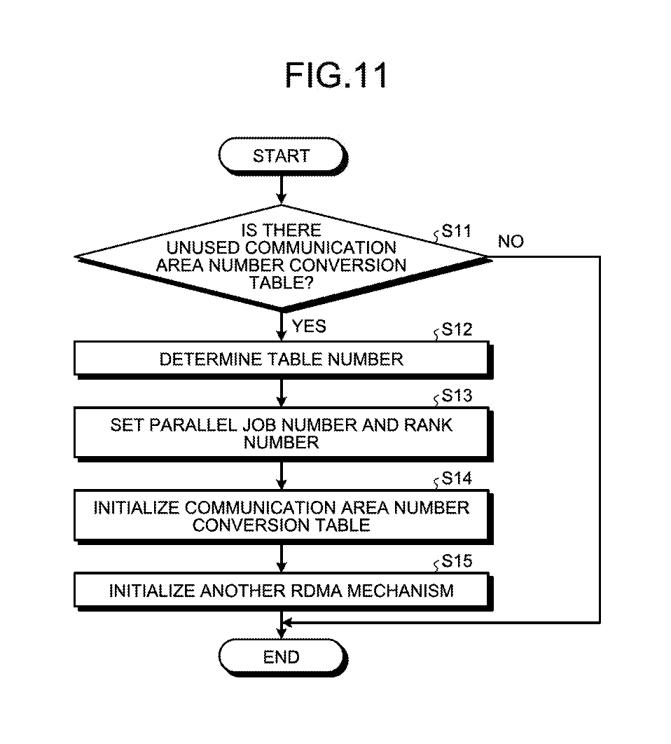

With reference to FIG. 11, a flow of the process of initializing the global address mechanism will be described. FIG. 11 is a flowchart of the process of initializing the global address mechanism. The process of the flowchart illustrated in FIG. 11 serves as an example of step S2 in FIG. 10.

The RDMA manager 103 determines whether there is the communication area number conversion table 144 unused (step S11). When there is not the communication area number conversion table 144 unused (NO at step S11), the RDMA manager 103 issues an error response and ends the process of initializing the global address mechanism. In this case, the computation node 1 issues an error notification and ends the preparation process for RDMA communication using the global address.

On the other hand, when there is the communication area number conversion table 144 unused (YES at step S11), the RDMA manager 103 determines a table number of each of the communication area number conversion tables 144 corresponding to each parallel processing number and each rank number (step S12).

The RDMA manager 103 then sets a parallel job number and a rank number corresponding to a corresponding communication area number conversion table 144 in each of the table selecting registers 411 to 414 that are provided in the table selecting mechanism 146 of the area converter 142 (step S13).

The RDMA manager 103 initializes the communication area number conversion tables 144 of the area converter 142 corresponding to the respective table numbers (step S14).

The RDMA manager 103 and the general manager 105 further execute initialization of another RDMA mechanism, for example, sets authority of a user process to access hardware for RDMA communication (step S15).

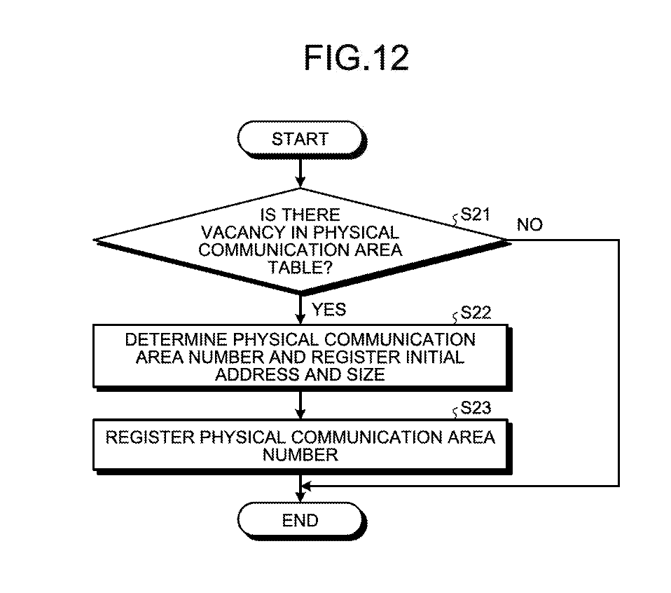

With reference to FIG. 12, a flow of the communication area registration process will be described. FIG. 12 is a flowchart of the communication area registration process. FIG. 12 is a flowchart of the communication area registration process. The process of the flowchart illustrated in FIG. 12 serves as an example of step S4 in FIG. 10.

The RDMA manager 103 determines whether there is a vacancy in the physical communication area table 145 (step S21). When there is no vacancy in the physical communication area table 145 (NO at step S21), the RDMA manager 103 issues an error response and ends the communication area registration process. In this case, the computation node 1 issues an error notification and ends the preparation process for RDMA communication using the global address.

On the other hand, when there is a vacancy in the physical communication area table 145 (YES at step S21), the RDMA manager 103 determines a physical communication area number corresponding to the initial address and the size. The RMDA manager 103 further registers the initial address and the size in association with an entry of the determined physical communication area number in the physical communication area table 145 of the address acquisition unit 143 (step S22).

The RDMA manager 103 registers the physical communication area number in the entry corresponding to a logical communication area number that is assigned to a distributed shared array in the communication area number conversion table 144 corresponding to the parallel processing number and the rank number (step S23).

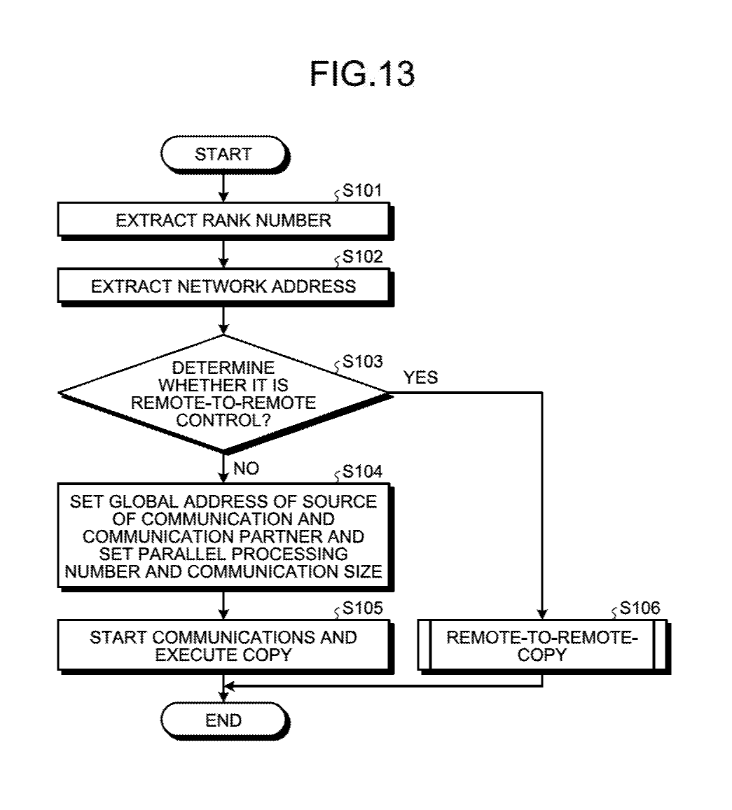

With reference to FIG. 13, the process of copying data by using RDMA communication will be described. FIG. 13 is a flowchart of the data copy process using RDMA communication.

The global address communication manager 102 extracts the rank number from a global address that is contained in a communication packet (step S101).

Using the extracted rank number, the global address communication manager 102 refers to the rank computation node correspondence table 201 and extracts the network address corresponding to the rank (step S102).

The global address communication manager 102 determines whether it is remote-to-remote copy from the addresses of the source of communication and the communication partner (step S103). When it is not a remote-to-remote copy (NO at step S103), i.e., when the communication involves the node, the global address communication manager 102 executes the following process.

The global address communication manager 102 sets the global address of the source of communication and the communication partner, the parallel processing number, and the size in the hardware register via the RDMA manager 103 (step S104).

The global address communication manager 102 writes a communication command according to the communication direction in the hardware register via the RDMA manager 103 and starts communication. The RDMA communication unit 104 executes a data copy by using RDMA communication (step S105).

On the other hand, when it is a remote-to-remote copy (YES at step S103), the global address communication manager 102 executes the remote-to-remote copy process (step S106).

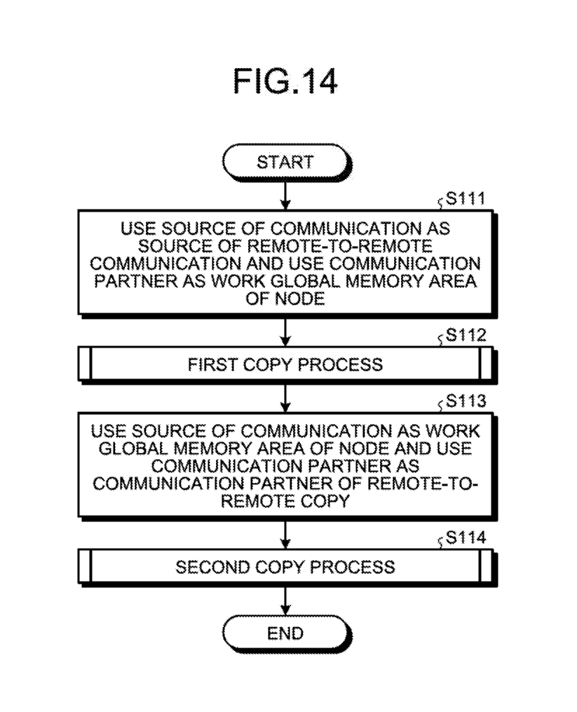

With reference to FIG. 14, the remote-to-remote copy process will be described. FIG. 14 is a flowchart of the remote-to-remote copy process. The process of the flowchart illustrated in FIG. 14 serves as an example of step S106 in FIG. 13.

The global address communication manager 102 uses the source of data transmission using RDMA communication as the source of data transmission of a remote-to-remote copy and sets the partner that receives data in a work global memory area of the node (step S111).

The global address communication manager 102 then executes a first copy process (RDMA GET process) with respect to the set source of communication and the communication partner (step S112). For example, step S112 is realized by performing the process at steps S104 and S105 in FIG. 13.

The global address communication manager 102 uses the source of data transmission usin RDMA communication as the work global memory area of the node and sets the communication partner for the partner that receives data in the remote-to-remote copy (step S113).

The global address communication manager 102 then executes a second copy process (PDMA PUT process) with respect to the set source of communication and the communication partner (step S114). For example, step 5114 is realized by performing the process at steps 5104 and S105 in FIG. 13.

As described above, the HPC system according to the embodiment assigns a unique logical communication area number to all ranks to which partial arrays of a distributed shared array are allocated in association with all ranks. The HPC system converts the logical communication area number to physical area numbers that are assigned to the respective ranks on the basis of the global address by using hardware, thereby implementing RDMM communication of a packet that is generated by using the logical communication area number. Thus, referring to a communication area management table representing physical communication area numbers of communication areas that are allocated to respective ranks is not needed in each communication, which enables high-speed communication processing.

The HPC system according to the embodiment need not have the communication area management table and thus it is possible to reduce utilization of memory areas and accordingly leave more memory areas for executing the parallel program.

### Modification

A modification of the HPC system 100 according to the first embodiment will be described. The first embodiment is described as the case where the partial arrays are equally allocated as the distributed shared array to all the ranks that execute the parallel processing; however, allocation of partial arrays is not limited to this.

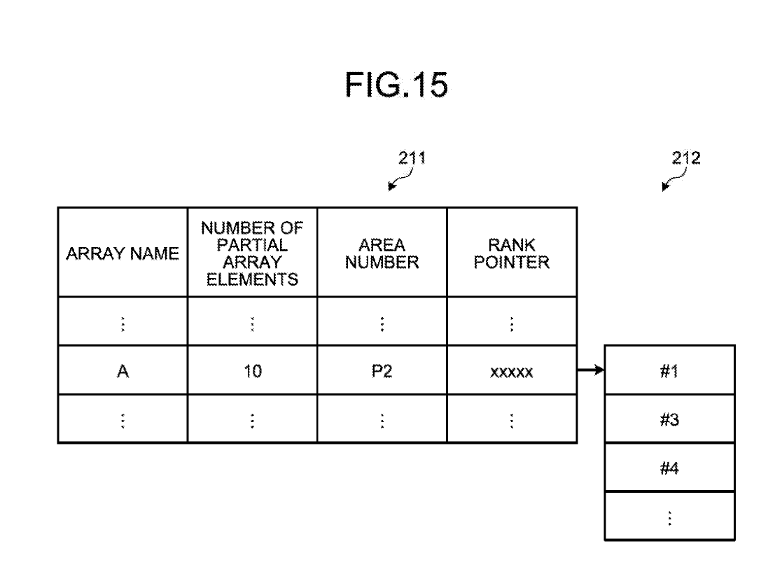

For example, when a distributed shared array is allocated to part of the ranks that execute the parallel processing, the global address communication manager 102 has a communication area management table 211 and a rank list 212. FIG. 15 is a diagram of an exemplary communication area management table in the case where the distributed shared array is allocated to part of ranks. According to the communication area management table 211, the number of partial array elements that are allocated to each rank of the distributed shared array whose array name is “A” is “10” and the logical communication area number is “P2”. The rank pointer of the communication area management table 211 indicates any one of entries in the rank list 212. In other words, the distributed shared array whose array name is “A” is not allocated to ranks that are not registered in the rank list 212. Also in this case, as the logical communication area number is uniquely determined with respect to the distributed shared array, the global address communication manager 102 of a rank to which the distributed shared array is not allocated need not register the logical communication area number in the communication area management table 211. Even in this case, the global address communication manager 102 is able to perform RDMA communication with a rank to which the distributed shared array is allocated by using the communication area management table 211 and the rank list 212.

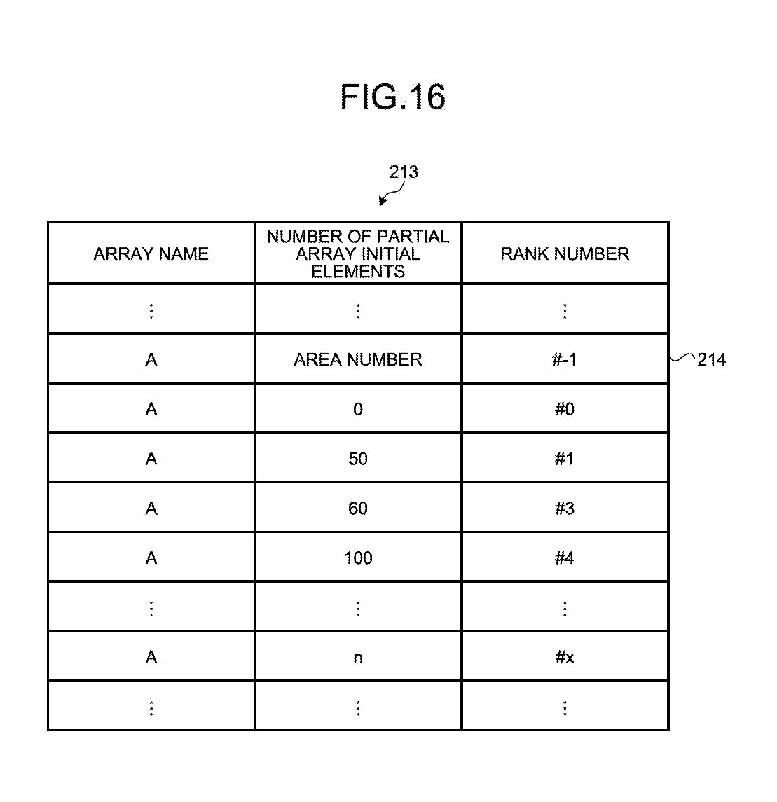

For example, when the size of partial array differs with respect to each rank, the global address communication manager 102 has a communication area management table 213 illustrated in FIG. 16. FIG. 16 is a diagram of an exemplary communication area management table in the case where the size of partial array differs with respect to each rank. The communication area management table 213 represents that partial arrays in different sizes are allocated respectively to the ranks of the distributed shared array whose array name is “A”. In this case, in the distributed shared array whose array name is “A”, a special entry 214 representing that an area number is registered in the column for partial array top element number is registered. Also in this case, it is possible to exclude a rank not sharing the distributed shared array whose array name is “A”. In this case, the global address communication manager 102 is able to perform RDMA communication by using the communication area management table 213.

The global address communication manager 102 is able to perform RDMA communication by using a table in which the communication area management tables 210, 211 and 213 illustrated in FIGS. 7, 15 and 16 coexist.

As described above, the HPC system 100 according to the modification is able to perform RDMA communication using the logical communication area number also when part of partial arrays do not share the distributed shared array or when the size of partial array differs with respect to each rank. In this manner, the HPC system 100 according to the modification enables high-speed communication processing regardless of the way to allocate a distributed shared array to ranks. Also in this case, the HPC system 100 need not have the communication area management table representing the physical communication areas of the respective ranks and thus it is possible to reduce utilization of memory areas and accordingly leave more memory areas for executing the parallel program.

### [b] Second Embodiment

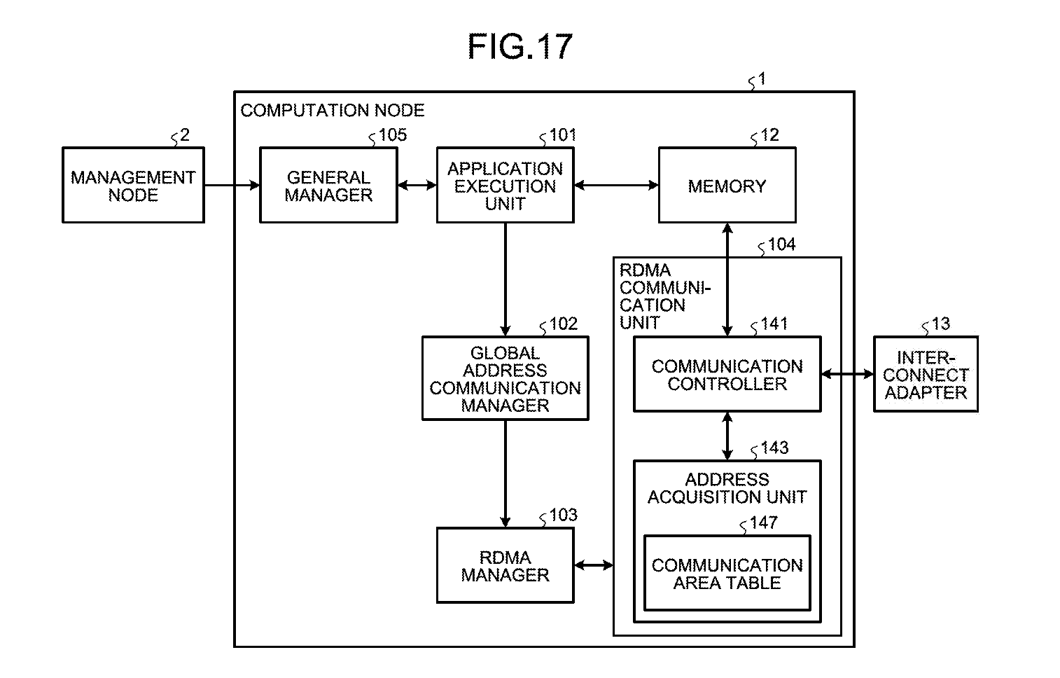

FIG. 17 is a block diagram of a computation node according to a second embodiment. The computation node according to the embodiment specifies a memory address of an array element to be accessed by using a communication area table 147 that is the collection of the communication area number conversion table 144 and the physical communication area table 145. The function of each unit the same as that in the first embodiment will be omitted below.

The address acquisition unit 143 includes the communication area tables 147 corresponding respectively to the table numbers that are determined by the global address communication manager 102. The communication area table 147 is a table in which an initial address and a size are registered in an entry corresponding to a logical communication area number. The communication area tables 147 are enabled with hardware. The communication area table 147 is an exemplary “correspondence table”. The address acquisition unit 143 includes the table selecting mechanism 146 in FIG. 8.

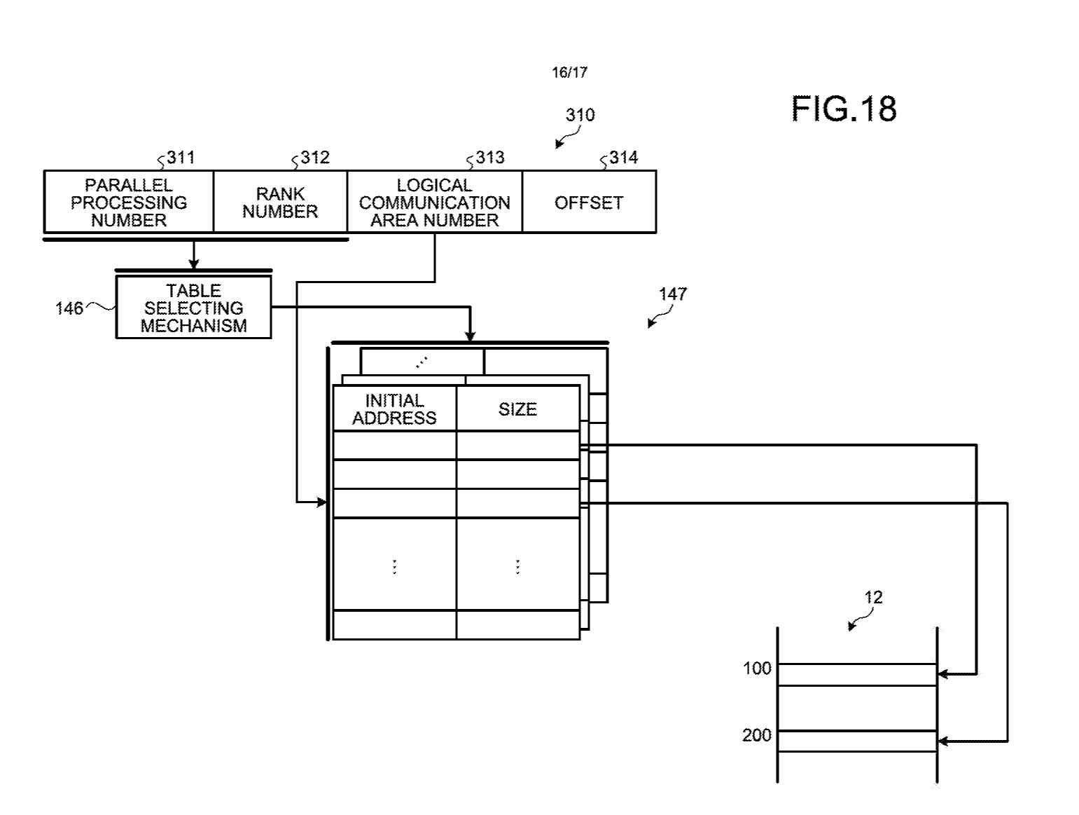

FIG. 18 is a diagram for explaining a process of specifying a memory address of an array element to be accessed, which is a process performed by the calculation node according to the second embodiment. Acquisition of a memory address of an array element to be accessed to communicate a communication packet having a packet header 310 will be described. The address acquisition unit 143 acquires a parallel processing number 311, a rank number 312 and a logical communication area number 313 that are stored in the packet header 310 from the communication controller 141. The address acquisition unit 143 uses the table selecting mechanism 146 to acquire the table number of the communication area table 147 to be used that corresponds to the parallel processing number 311 and the rank number 312.

The address acquisition unit 143 selects the communication area table 147 corresponding to the acquired table number. The address acquisition unit 143 then uses the logical communication area number to the selected communication area table 147 and outputs the initial address and the size corresponding to the logical communication area number.

The communication controller 141 then obtains a memory address of an array element to be accessed by using an offset 314 to the initial address and the size that are output from the address acquisition unit 143. The communication controller 141 then accesses the obtained memory address in the memory 12.

As described above, the HPC system according to the embodiment is able to specify the memory address of an array element to be accessed without converting a logical communication area number into a physical communication area number. This enables faster communication processing.

According to the above descriptions, communication is performed by loopback of communication hardware, such as a RDMA-NIC, that the RDMA communication unit 104 includes in both cases where the ranks of the source of communication and the communication partner are the same and when the ranks are different from each other but the same computation node is used. Note that, in such a case, process-to-process communication by software in the shared memory or the computation node 1 may be used for a process in which the initial address and size are acquired from a logical communication area number to specify the memory address an array element to be accessed to perform RDMA communications are performed.

The data communication in the case where the distributed shared array is shared by each rank has been described. Alternatively, when information is stored in the memory by using another value, it is possible to communicate the value by using a logical communication area number.

For example, when a variable is shared by each, the variable that each rank has is represented by the memory address. The global address communication manager 102 is able to manage the variable by replacing the array name with a variable name and by using the same table as the communication area management table 213 as in the case where a distributed shared array is shared.

Also in this case, the cross compiler 23 assigns logical communication area numbers as values representing the variables of the respective rank has.

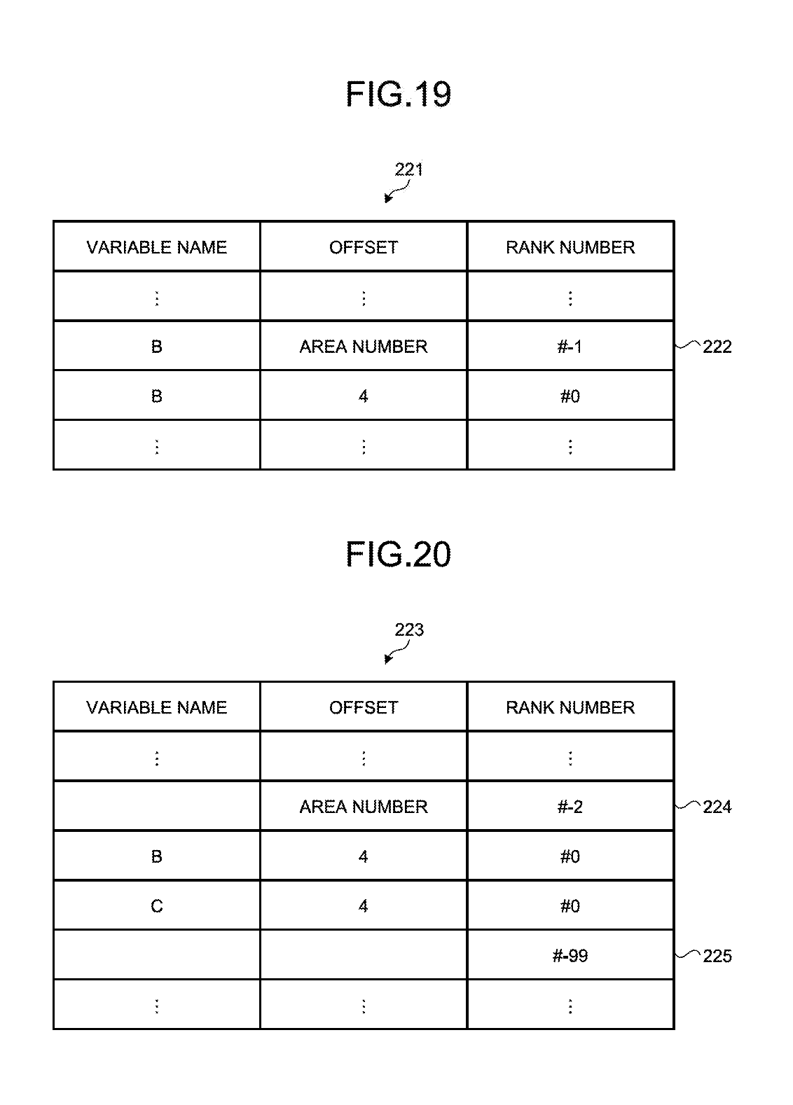

The global address communication manager 102 acquires the area number of the memory address representing the variable of each rank. The global address communication manager 102 generates a variable management table 221 illustrated in FIG. 19. FIG. 19 is a diagram of an exemplary variable management table. It is difficult to keep the sizes of variables uniform. As in the case where the partial arrays have different sizes, the global address communication manager 102 registers a special entry 222 representing an area number and then registers a offset of the variable having the variable name and the rank number.

The global address communication manager 102 and the RDMA manager 103 generate various tables for obtaining a memory address of an array element to be accessed from the logical communication area number by using the parallel processing number, the rank number and the logical communication area number. The global address communication manager 102 specifies a rank by using the variable management table 221. Furthermore, the RDMA communication unit 104 performs RDMA communication by using the various tables for obtaining a memory address of an array element to be accessed from the logical communication area number.

When one memory is left for one variable, the resources may be depleted. To deal with this, a memory area for gathering shared variables in a rank may be left and managed by using offset. For example, when there are shared variables X and Y, the global address communication manager 102 generates a variable management table 223 illustrated in FIG. 20 and executes RDMA communication by using the variable management table 223. FIG. 20 is a diagram of an exemplary variable management table that collectively managers the two shared variables. In this case, the variable management table 223 has a special entry 224 representing an area number. In the variable management table 223, an offset and a rank number are registered with respect to a variable name. The variable management table 223 also has a special entry 225 representing separation between areas.

Also in this case, as in the case where a distributed shared array is shared, the global address communication manager 102 and the RDMA manager 103 create various tables for obtaining a memory address of an array element to be accessed from a logical communication number by using a parallel processing number, a rank number and a logical communication area number. The global address communication manager 102 then specifies a rank by using the variable management table 223. Furthermore, the RDMA communication unit 104 performs RDMA communication by using the various tables for obtaining a memory address of an array element to be accessed from the logical communication area number.

According to a mode of the parallel processing apparatus and the node-to-node communication method disclosed herein, there is an effect that high-speed communication processing is enabled.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A parallel processing apparatus comprising:
a generator that generates a logical communication area number for first identifying information that is assigned to each of multiple processes contained in parallel processing;
an acquisition unit that keeps correspondence information that makes it possible to, on the basis of the first identifying information and second identifying information representing the parallel processing, specify a memory area that is allocated according to each set of the second identifying information corresponding to the logical communication area number, receives a communication instruction containing the first identifying information, the second identifying information and the logical communication area number, and acquires a memory area corresponding to the acquired logical communication area number on the basis of the correspondence information; and
a communication unit that performs communication by using the memory area that is acquired by the acquisition unit.

2. The parallel processing apparatus according to claim 1, further comprising:
a memory area determination unit that determines the memory areas to be allocated to the respective sets of the first identifying information when the parallel processing is executed; and
a correspondence information generator that generates the correspondence information by associating each of the memory areas to be allocated to respective sets of the first identifying information, which are determined by the memory area determination unit, with the logical communication area number.

3. The parallel processing apparatus according to claim 1, wherein
the acquisition unit includes:
a specifying unit that keeps first correspondence information representing correspondence between the logical communication area number and a physical communication area number that is assigned to each set of the second identifying information and specifies, on the basis of the first correspondence information, the physical communication area number corresponding to the acquired logical communication area number; and
an extraction unit that keeps second correspondence information representing correspondence between the physical communication area number and the memory area and extracts the memory area on the basis of the physical communication area number that is specified by the specifying unit and the second correspondence information.

4. The parallel processing apparatus according to claim 1, wherein the acquisition unit has, as the correspondence information, a correspondence table that makes it possible to specify the memory area corresponding to the logical communication area number on the basis of the first identifying information and the second identifying information.

5. A node-to-node communication method comprising:
generating a logical communication area number for first identifying information that is assigned to each of multiple processes contained in parallel processing;
receiving a communication instruction containing the first identifying information, second identifying information representing the parallel processing, and the logical communication area number;
acquiring the first identifying information, the second identifying information, and the logical communication area number from the received communication instruction;
acquiring a memory area corresponding to the acquired logical communication area number by using correspondence information that makes it possible to, on the basis of the first identifying information and the second identifying information, specify a memory area that is allocated according to the second identifying information corresponding to the logical communication area number; and
performing communication by using the acquired memory area.
